(19) United States
(12) Patent Application Publication
(10) Pub. No.: US 2013/0204949 A1
(43) Pub. Date: Aug. 8, 2013

(54) METHOD FOR LAUNCHING A CONTEXTUALIZED ON-THE-FLY CONFERENCE

(71) Applicants: Jerome Elleouet, Brest (FR); Frederic Priam, Brest (FR)

(72) Inventors: Jerome Elleouet, Brest (FR); Frederic Priam, Brest (FR)

(73) Assignee: ALCATEL LUCENT, Paris (FR)

(21) Appl. No.: 13/696,225

(22) PCT Filed: Mar. 16, 2011
(86) PCT No.: PCT/FR11/50527

§ 371 Date: Jan. 31, 2013

(30) Foreign Application Priority Data
May 5, 2010 (FR) 1001933

(51) Int. Cl. H04L 29/08

(52) U.S. Cl. CPC H04L 67/10
USPC 709/206

(57) ABSTRACT

A method for launching a contextualized on-the-fly conference between at least two users connected to a unified communications client and whose respective email addresses are included in an email, which method includes the following steps:
extracting the email addresses comprised within the email's header;
extracting a context from the email;
formatting a contextualized on-the-fly conference request with the help of the extracted email addresses and context;
transmitting the formatted request to a conference server;
opening, for each user, an instant messaging session via the unified communications client;
loading the extracted context in the open instant messaging session.

The present invention relates to the technical field of organizing group electronic communications over an electronic communications network. A common application in this field is organizing a video conference, audio conference, or instant text electronic communication, with or without document- or application-sharing, between two or more people who have terminals such as computers, mobile telephones, PDAs (personal digital assistants), or other terminals.

The invention particularly pertains to organizing a contextualized on-the-fly conference.

Some aspects of the invention derive from the observation that the practice of video conferencing via unified communications lines (such as My Teamwork™ (published by Alcatel-Lucent), Skype™, Microsoft Office Communicator™, Yahoo! Messenger™, Lotus Sametime™) are experiencing tremendous popularity. This is because video conferencing makes it possible to realize savings while avoiding costs related to transportation and all related fees.

However, on a day-to-day basis, after reading/checking an email or email thread via an electronic messaging or collaborative work system (such as IBM Lotus Notes™, Microsoft Outlook™, Mozilla Thunderbird™), a user sometimes wants to immediately launch a video conference (known as an Instant Meeting Conference) with the users concerned by that email thread, in order to update them on the subject of those emails, for example. When doing so, he or she is required
to organize the video conferencing via the unified communication client by identifying their respective contacts, who are assumed to be on his or her contacts list on that client, and incorporating them manually one contact at a time;
once the people have joined that video conference (those who accepted his or her invitation), to remind all the participants of the context of that video conference.

At the start of that video conference, a written and/or spoken dialog of the following style is often observed:
“in the attachment to his email dated January 10, Michel Mentioned . . . ”/“one moment please, I'm looking for the email in my Inbox . . . ”/“I don't have that email . . . ”/“Okay I'll send it to you Again . . . ”/“I'm connected from another machine, I can't access my Emails . . . ”;
“have you all gotten the necessary documents?”/“do you remember the idea that I mentioned in my very first email . . . ”/“Remind us about that idea . . . ”, and so on.

As a result, precious time is lost:
identifying (making sure to include the right contact) and then inviting those contacts; and
giving context to that video conference's participants.

Obviously, this method is not conducive to the success of group electronic communications such as collaborative work, particularly because it is tedious (manual handling and integration) and especially time-inefficient.

One purpose of this invention is to remedy the aforementioned drawbacks.

Another object of the present invention is to improve the procedure for beginning a conference with contacts included in an email thread.

Another object of the present invention is to offer the user an intuitive way to launch, from an email, an instant meeting video conference with the contacts who are included there.

Another object of the present invention is to allow the fast, efficient organization of conferences, without prior reservation, with work colleagues, clients, and/or partners on a national or international level.

Another object of the present invention is to optimally encourage the conditions needed for a fast, efficient “Instant Meeting Conference”.

Another object of the present invention is to make organizing a contextualized on-the-fly conference simple and intuitive.

Another object of the present invention is to combine the advantages of information and communication environments, particularly messaging systems, with those of a unified communications client.

Another object of the present invention is to allow the fast organizing of a contextualized on-the-fly conference with the help of the user's normal resources (an email client and a unified communications client).

To that end, the invention pertains, according to a first aspect, to a method for launching a contextualized on-the-fly conference between at least two users connected to a unified communications client and whose respective email addresses are included in an email, which method includes the following steps:
extracting the email addresses comprised within the email's header;
extracting a context from the email;
formatting a contextualized on-the-fly conference request with the help of the extracted email addresses and context;
transmitting the formatted request to a conference server;
opening, for each user, an instant messaging session via the unified communications client;
loading the extracted context in the open instant messaging session.

According to a second aspect, the invention discloses an email client comprising:
a means of ordering a contextualized on-the-fly conference between at least two users connected to a unified communications client and whose respective email addresses are comprised within an email, which means is configured to
extract the email addresses comprised within the email's header;
extract a context from the email;
format a contextualized on-the-fly conference request with the help of the extracted email addresses and context;
transmit the formatted request to a conference server, upon the receipt of said request,
   the conference server being configured to open, for each user, an instant messaging session via the unified communications client, and to load the extracted context into a launched instant messaging session.

According to a third aspect, the invention pertains to a computer program product implemented on a memory medium, which may be implemented within a computer processing unit, and comprises instructions for implementing the method summarized above.

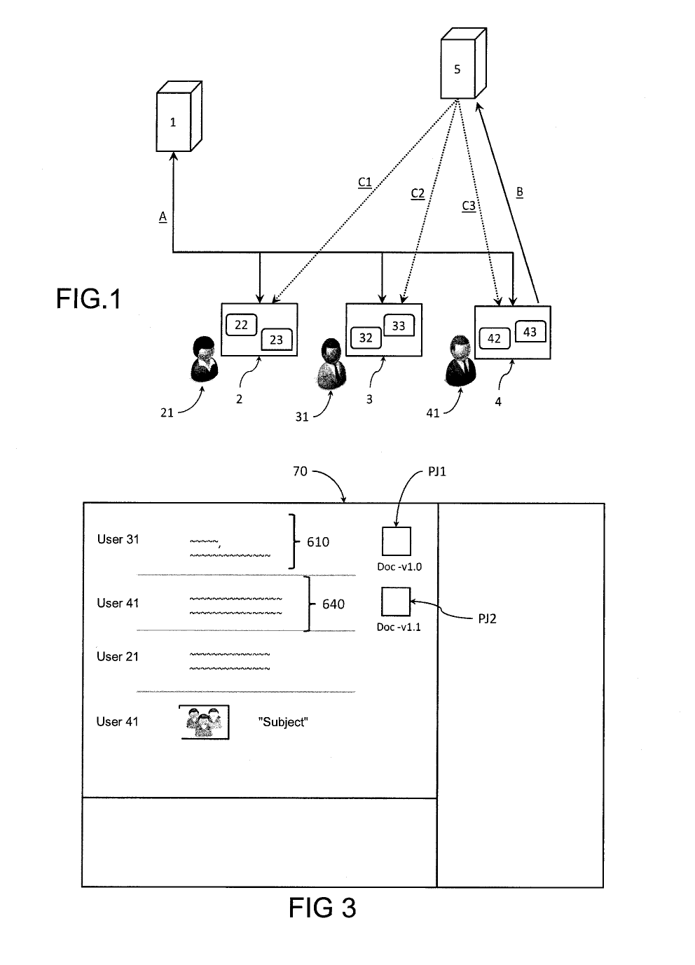

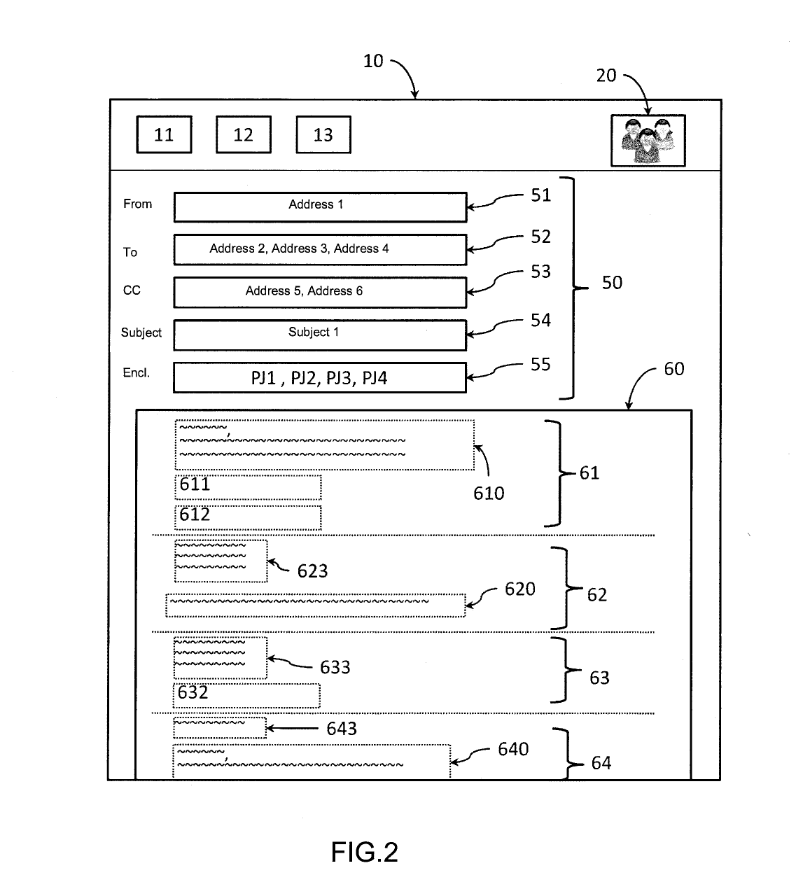

Other characteristics and advantages of the invention will become more clearly and completely apparent upon reading the description below of preferred embodiments, which is done with reference to the attached drawings in which:
FIG. 1 schematically depicts one embodiment;
FIG. 2 schematically depicts one means of ordering a contextualized on-the-fly conference; and
FIG. 3 schematically depicts the effect produced by one embodiment.

FIG. 1 shows a plurality of users 21, 31, 41, equipped, respectively, with a user terminal 2, 3, 4. A desktop computer, laptop computer, or smartphone mobile terminal are examples of user terminals 2, 3, 4.

As indicated in FIG. 1, each of the user terminals 2, 3, 4 comprises an email client 22, 32, 42 and a unified communications client 23, 33, 43.

The email client 22, 32, 42 (IBM Lotus Notes™, Microsoft Outlook™, Mozilla Thunderbird™, Eudora™, Pocket Outlook™, IceDove™, Palm VersaMail™ for example) makes it possible to send electronic messages (or emails), with or without attachments, via a communications network (commonly the Internet or an intranet network shared by the user terminals 2, 3, 4) to an email inbox of at least one recipient 21, 31, 41 chosen by the sender 21, 31, 41. To do so, the email client 22, 32, 42 is connected to an email server 1. Thus, the email client 22, 32, 42 additionally makes it possible to receive and read emails that are transmitted to it from the email server 1 (link A in FIG. 1).

It should be noted that the email server 1 may comprise multiple co-located or distributed servers.

It should also be noted that the email client 22, 32, 42 may also be a webmail client, which particularly makes it possible to check/send an email from a web interface accessible via a web browser.

The unified communications client 23, 33, 43 (My Teamwork™ (published by Alcatel-Lucent), Microsoft Office Communicator™, Yahoo! Messenger™, Skype™, or Lotus Sametime™ for example) generally offers a plurality of services comprising
means for real-time communications between users 21, 31, 41, such as videophony, fixed and mobile telephony, video conferencing, audioconferencing, instant messaging; and
collaborative work tools such as presence management (connected, communicating, busy, disconnected, for example), and sharing and management of documents (files) and applications (a whiteboard, for example).

The unified communications clients 23, 33, 43 respectively used by the users 21, 31, 41 are preferentially identical or at least compatible. In other words, the unified communications clients 23, 33, 43 make it possible to establish at least one mode of communication (text, audio, video, or a combination thereof) and to share data or applications between the users 21, 31, 41. To that end, the unified communications clients 23, 33, 43 are connected to at least one conference server 5.

Now with reference to FIG. 2, an email or email thread window 10 comprises, generally,
a plurality of graphical user interface components 11-13 of commands (buttons: “Reply”, “Reply All”, “Forward”, or “Delete”, for example, menus: “File”, “Edit”, for example), groups (of tabs, for example), navigation (“Minimize”, “Close” or “Scrollbar”, for example);
a header 50 of the email (or email thread) including a “From:” field 51, which indicates an email address “address1” of a sender; a “TO:” field 52, which indicates at least one email address of a recipient address2-address4; a “CC” (carbon copy) field 53, which also indicates at least one email address of a recipient address5-address6; a “subject” field 54, which indicates the subject of the email or email thread; an “Attachments” field 55, which indicates—if any exist—one or more attachments PJ1-PJ4 to the email;
an email body 60 including one or more email content(s) 61-64; and
a means of ordering 20 a contextualized on-the-fly conference.

The email content 61-64 may particularly comprise,
informational content, such as, for example:
a sender's signature 611;
a confidentiality message 612, 632;
elements 623, 633, 643 comprising, by way of example, the fields “From:”, “To:”, “CC:”, “Subject:”, “Importance:”, “Sent on:”);
messages 610, 620, 640 that may be classified into
informative messages 610, 640 (relevant or useful with regard to the e-mail subject), written by senders; and
uninformative messages 620, such as an automatic reply programmed by the sender and/or the email server 1 or a blank message (as with a forwarded email, for example).

In particular, the means for ordering 20 the contextualized on-the-fly conference make it possible
to invite all users whose email addresses are present in the fields of the header 50 (particularly, the “From” field 51, the “To” field 52, and the “CC” field 53) to a conference via the unified communications client 23, 33, 43; and
to automatically create the context for that conference.

To do so, the means for ordering 20 the contextualized on-the-fly conference is configured to:
extract email addresses comprised within the “From” field, the “To” field 52, and the “CC” field 53 of the header 50;
extract, from the email, a context made up of at least the “subject” field 54, attachments PJ1-PJ4, and informative messages 610, 640 with the dates they were sent comprised within the elements 623, 633, 643;
format a contextualized on-the-fly conference request using the extracted data;
transmit the formatted request to the conference server 5 (link B in FIG. 1) in view of inviting, via their unified communications clients 23, 33, 43, the owners of the extracted email addresses.

Preferentially, the context (or framework) of the instant meeting conference comprises:
a subject extracted from the “subject” field 54;
senders, defined by email addresses extracted from the “From” field 51 for from the elements 623, 633, 643 and respectively associated
with their informative messages 610, 640, extracted from the body 60 of the email; and
with their attachments PJ1-PJ4 to their informative messages 610, 640.

In one variant or in a combination, the means of ordering 20 is equipped
with a means of semantic analysis (“opinion mining tools”, such as scanning means);
ontology metadata (such as those of WordNet®, SentiWordNet®, ConceptNet®); and/or
means of extracting named entities (Nadeau D. et al, “A survey of named entity recognition and classification”, Linguisticae Investigationes, January 2007).
   making it possible
to identify the informative messages 610, 640 from among the messages 610, 620, 640; and then
to perform a semantic analysis of the informative messages 610, 640, and to provide a semantic summary of those messages. This semantic analysis makes it possible to extract the relevant information comprised within the informative messages 610, 640 by eliminating from them, for example, the niceties (the messages that open and close a message, salutations, thanks).

The subject extracted from the “subject” field 54 serves as a title for the conference launched by the conference server 5. The extracted subject may particularly be edited by deleting from it, for example, expressions like “Fwd:” (generally used to designate a forwarded email, for example) or “Re:” (generally used to designate a reply email).

In one variant, the subject of the conference launched by the conference server 5 is deduced semantically (cloud of tags, frequency of use of a certain term/concept) from the informative messages 610, 640 and/or from the attachments PJ1-PJ4. Preferentially, this subject is deduced from the most recent exchanges in that email thread.

The request transmitted to the conference server 5 (link B of FIG. 1) comprises
email addresses extracted from the header 50 of the email;
a conference subject, extracted from the “subject” field 54 or deduced semantically from the email content 61-64, and
attachments PJ1-PJ4 and informative messages 610, 640 (preferably dated) or a semantic summary thereof, associated with their respective sender email addresses.

After that request has been received by the conference server 5, that server does the work of (links C1, C2 and C3 in FIG. 1):
opening an instant messaging session to all participants using their email addresses; and
launching the sharing, between the participants, of the informative messages 610, 640 and attachments PJ1-PJ4, extracted from the email thread (in other words, putting the conference into context).

The result is the triggering of a conference that is
instant: an Instant Meeting Conference, meaning one without prior reservations;
automatically placed in context: the subject of the email, the informative messages 610, 640 comprised within the exchanged emails and the attachments are automatically loaded in an instant messaging session.

Furthermore, the conference server 5 is configured to resolve the email addresses comprised within a conference request. In other words, the conference server 5 is operative to find, within the means of unified communications 23, 33, 43, the identifiers of the users who own the email addresses comprised within the conference request.

By way of example, illustrated by FIG. 3, assuming that a user 41 launched, from his or her email client, a contextualized on-the-fly conference on the subject of an email thread in which the email addresses of the users 21 and 31 (and particularly his or her own) appear, an in-context instant messaging session 70 is opened by the conference server 5 for the three users 21, 31, and 41.

The instant messaging session 70, managed by the unified communications agent 23, 33, 43 that particularly supports other modes of communication (audio, video, for example), incorporates the informative messages 610, 640 extracted from the email's body 60 with their respective attachments PJ1 (doc-v1.0) and PJ2 (doc-v1.1). The user 41—who triggered that Conference—is designated the leader of the conference.

In one embodiment, the contextualized on-the-fly conference request is sent to a storage server, other than the conference server 5, configured to store, for at least the duration of the conference, the attachments to the email thread. The instant meeting conference request is then transferred to the conference server 5 which, in turn, launches an instant messaging session referring to the attachments stored in the storage server.

The means for ordering 20 a contextualized on-the-fly conference may take the form of a graphical user interface component that calls on the aforementioned functions, within an electronic messaging client (Microsoft Outlook, IBM Lotus Notes, for example), a webmail client accessible via a web browser, or installed software providing an interface suitable for mobile terminals (whether touchscreen or not).

In one embodiment, the means of ordering 20 a conference offers a plurality of options, such as:
editing the email addresses extracted from the header 50: adding a new address (that of a conference interpreter, for example), deleting an email address (that of the team's manager, for example);
including email addresses comprised within the “BCC” (Blind Carbon Copy) field;
ignoring the content 61-64 of the email thread dated more than 6 months ago, for example;
ignoring attachments whose size is greater than a certain value or certain type, for example;
displaying the date when the emails whose content is shared between the users 21, 31 41 in the instant messaging session 70 were sent;
inviting only users whose presence state, in the unified communications client 23, 33, 43, is “available”;
only launching the conference when at least n users are deemed “available” according to the presence server of the unified communications client 23, 33, 43;
scheduling that conference in my calendar (will start at 2:10 p.m. today, for example);
ignoring the group email addresses (one distribution email address, for example);
grouping, in the instant messaging session 70, the informative messages 610, 640 as well as the attachments by user. By way of example, if the informative messages 610, 640 extracted from the email body 60 include two messages—M1 with an attachment PJ1, and M2 with no attachment—respectively sent on Nov. 25, 2008 and Apr. 4, 2009, by the user 21, then load, in the instant messaging session 70, the message M1 with the attachment PJ1, and the message M2, both associated with the user 21.

Advantageously, the users 21, 31 invited to a contextualized on-the-fly conference can attend it only via the unified communications client 23, 33, regardless of whether they can or can't access their email inboxes. Preferably, in such a case, the shared data is loaded in the user terminal's volatile memory or in a secure session.

The method just described exhibits a certain number of advantages. In particular, it makes it possible:
for the user to be able to organize a conference instantly in just one click that incorporates all users whose email addresses are present in the header 50 of an email;
to reduce the participants' reaction time, by recreating the context of the conference (the subject of the conference, the attachments PJ1-PJ4 and the informative/relevant messages 610, 640 of the email) brought in from the email exchanges between them.

1. A method for launching a contextualized on-the-fly conference between at least two users connected to a unified communications client and whose respective email addresses are included in an email, which method includes the following:
extracting the email addresses comprised within the email's header;
extracting a context from the email;
formatting a contextualized on-the-fly conference request with the help of the extracted email addresses and context;
transmitting the formatted request to a conference server;
opening, for each user, an instant messaging session via the unified communications client;
loading the extracted context in the open instant messaging session

2. A method according to claim 1, wherein extracting context from an email comprises a stop of extracting at least one attachment to the email, associated with an extracted email address.

3. A method according to claim 1, wherein extracting a context from the email comprises extracting at least one informative message from the body of the email, associated with an extracted email address.

4. A method according to claim 1, wherein extracting a context from the email comprises extracting the subject of the email.

5. A method according to claim 1, wherein loading the context comprises the conference server launching the sharing, in the launched session, of at least one extracted informative message.

6. A method according to claim 1, wherein loading the context comprises the conference server launching the sharing, in the launched session, of at least one extracted attachment.

7. A method according to claim 1, wherein the email addresses are extracted from the “From” field, the “To” field, and the “CC” field of the email's header.

8. A method according to claim 1, wherein the conference server is operative to resolve the email addresses of the users.

9. A method according to claim 1, wherein the email is an email thread.

10. A method according to claim 1, wherein the subject of the conference is deduced semantically from the informative messages.

11. An email client comprising
a means of ordering a contextualized on-the-fly conference between at least two users connected to a unified communications client and whose respective email addresses are comprised within an email, which means is configured to
extract the email addresses comprised within the email's header;
extract a context from the email;
format a contextualized on-the-fly conference request with the help of the extracted email addresses and context;
transmit the formatted request to a conference server, upon the receipt of said request,
the conference server being configured to open, for each user, an instant messaging session via the unified communications client, and to load the extracted context into a launched instant messaging session.

12. An email client according to claim 11, wherein the conference server is operative to resolve the email addresses of the users.

13. A computer program product implemented on a memory medium, which may be implemented within a computer processing unit, and comprises instructions to implement a method according to claim 1.
